(19) United States
(12) Patent Application Publication
(10) Pub. No.: US 2008/0010359 A1
(43) Pub. Date: Jan. 10, 2008

(54) COMPUTER IMPLEMENTED METHOD AND SYSTEM FOR MANAGING SERVER-BASED RENDERING OF MESSAGES IN A HETEROGENEOUS ENVIRONMENT

(76) Inventors: Jeffrey Mark Achtermann, Austin, TX (US); Andrew William Lucchesi, Austin, TX (US); Navin D. Manohar, Pflugerville, TX (US); Victor Gee Yiu, Austin, TX (US)

Correspondence Address: IBM CORP (YA);C/O YEE & ASSOCIATES PC, P.O. BOX 802333, DALLAS, TX, 75380, US

(21) Appl. No.: 11/456,225

(22) Filed: Jul. 10, 2006

(51) Int. Cl. G06F 15/16

(52) U.S. Cl. 709/217; 709/203

(57) ABSTRACT

Computer implemented method, system and computer usable program code for rendering messages in a data processing system. A computer implemented method for rendering a message in a data processing system includes updating a source object of a secondary web page associated with a primary web page with information regarding a message to be rendered. The information is transmitted to a remote location using the secondary web page. Message code is received from the remote location that includes the message to be rendered and message rendering instructions, and the received message code is processed to render the message for display on the primary web page.

### BACKGROUND OF THE INVENTION

1. Field of the Invention

The present invention relates generally to the data processing field and, more particularly, to a computer implemented method, system and computer usable program code for rendering messages in a data processing system.

2. Description of the Related Art

With software being sold throughout the world, it is often not sufficient for software applications to display status and messages only in English. Typically, various sets of translated localized messages must be made for each message, and this usually calls for a centralized message catalog that holds the messages, and that can be accessed through a unique key.

A message catalog can be provided at every location that needs to generate a message, and this is sometimes done by duplicating a message catalog for each location. Providing duplicate message catalogs, however, can cause maintenance and consistency problems in addition to requiring additional storage. A preferred alternative, accordingly, is to provide one message catalog at a central location. However, in mixed-language distributed applications, maintaining consistent message rendering, both textually and formatting, can be a challenge without substantial code duplication.

Consider a typical scenario of a Web server generating an error message initiated by server side code (in HTML to be rendered by a client browser). Assuming both the message content and the message rendering mechanisms reside on the server, this is a relatively simple procedure since everything is at one location and is accessible internally.

When, however, a rendered message is needed from an event generated or initiated on the client side, without having the message catalog or rendering engine, procedures become more difficult. This could be a Java™ applet or Javascript™ running on the user's Web browser, for example. Field input validation or file uploading is a common activity in this scenario.

There is, accordingly, a need for a mechanism that will facilitate managing server-based rendering of messages in a data processing system.

### SUMMARY OF THE INVENTION

Exemplary embodiments provide a computer implemented method, system and computer usable program code for rendering messages in a data processing system. A computer implemented method for rendering a message in a data processing system includes updating a source object of a secondary web page associated with a primary web page with information regarding a message to be rendered. The information is transmitted to a remote location using the secondary web page. Message code is received from the remote location that includes the message to be rendered and message rendering instructions, and the received message code is processed to render the message for display on the primary web page.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an exemplary embodiment when read in conjunction with the accompanying drawings, wherein:

FIG. 1 depicts a pictorial representation of a network of data processing systems in which exemplary embodiments may be implemented;

FIG. 2 is a block diagram of a data processing system in which exemplary embodiments may be implemented;

FIG. 3 depicts a typical software architecture for a server-client system in accordance with an exemplary embodiment;

FIG. 4 is a block diagram that schematically illustrates a system for managing server-based rendering of messages in a data processing system according to an exemplary embodiment; and

FIG. 5 is a flowchart that illustrates a computer implemented method for managing server-based rendering of messages in a data processing system according to an exemplary embodiment.

### DETAILED DESCRIPTION OF THE PREFERRED EMBODIMENT

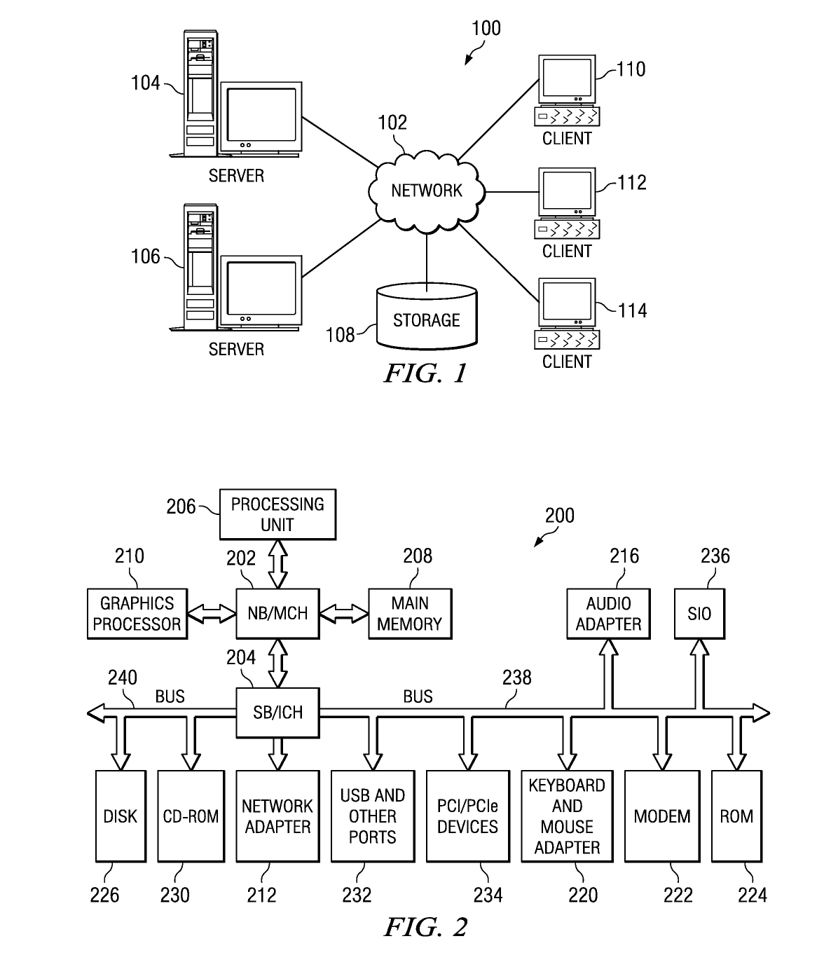

With reference now to the figures and in particular with reference to FIGS. 1-2, exemplary diagrams of data processing environments are provided in which exemplary embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which exemplary embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which exemplary embodiments may be implemented. Data processing system 200 is an example of a computer, such as server 104 or client 110 in FIG. 1, in which computer usable code or instructions implementing the processes may be located for the exemplary embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

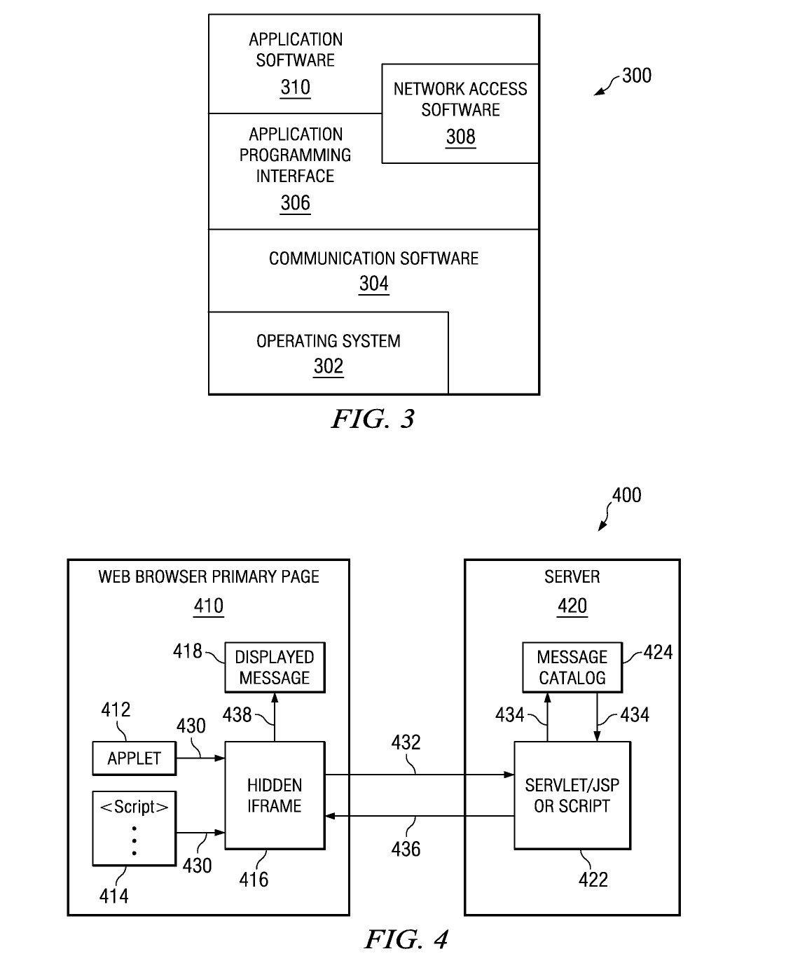

Turning to FIG. 3, typical software architecture for a server-client system is depicted in accordance with an exemplary embodiment. The architecture is generally designated by reference number 300. At the lowest level, operating system 302 is utilized to provide high-level functionality to the user and to other software. Such an operating system typically includes a basic input output system (BIOS). Communication software 304 provides communications through an external port to a network such as the Internet via a physical communications link by either directly invoking operating system functionality or indirectly bypassing the operating system to access the hardware for communications over the network.

Application programming interface (API) 306 allows the user of the system, an individual, or a software routine, to invoke system capabilities using a standard consistent interface without concern for how the particular functionality is implemented. Network access software 308 represents any software available for allowing the system to access a network. This access may be to a network, such as a local area network (LAN), wide area network (WAN), or the Internet. With the Internet, this software may include programs, such as Web browsers. Application software 310 represents any number of software applications designed to react to data through the communications port to provide the desired functionality the user seeks. Applications at this level may include those necessary to handle data, video, graphics, photos or text, which can be accessed by users of the Internet. The mechanism of the present invention may be implemented within communications software 304 in these examples.

Exemplary embodiments provide a computer implemented method, system and computer usable program code for rendering of messages in a data processing system. More particularly, exemplary embodiments provide a computer implemented method, system and computer usable program code for managing server-based rendering of messages in a data processing system within a heterogeneous environment.

According to exemplary embodiments, a secondary document, referred to herein as a “secondary web page” is associated with a primary document, referred to herein as a “primary web page” on which a rendered message is to be displayed. A source object of the secondary web page is updated with information regarding the message to be rendered, and the information is transmitted to a remote location using the secondary web page. Message code is received from the remote location that includes the message to be rendered and message rendering instructions, and the received message code is processed to render the message for display on the primary web page.

According to exemplary embodiments, the secondary web page is provided by background connection to a server, and can be associated with the primary web page by being embedded in the primary web page, by being positioned adjacent to the primary web page or in another suitable manner. According to an exemplary embodiment, connection to the server can be initiated by a Java applet embedded into a web page or by Javascript code or another scripting language, such as VBScript (Virtual Basic Scripting), running on a client browser. This can be achieved without the entire viewable page refreshing.

According to an exemplary embodiment, the background connection to the server is initiated using an IFRAME (inline frame) object, although it should be understood that other mechanisms can also be used. The IFRAME object serves as a secondary web page embedded within the primary web page, and provides the advantage that it can be hidden on the client browser's primary web page:

<iframe src=“” id=“iframeid” style=“display: none”>
</iframe>

The IFRAME object is referenced by an ID tag via the Javascript function:

document.getElementById( )

The Javascript code on the web page can directly access this function, while an embedded Java applet can use the LiveScript JSObject method exec( ) to access DOM (Document Object Model) elements on the primary Web page. When a message that resides on the server needs to be displayed in the client browser, Javascript code running in the browser updates the source of the document content for the hidden IFRAME object:

document.getElementById(‘iframeid’).src=newURL

The browser processes the URL and contacts the Web server to retrieve the new content. As will be described in greater detail hereinafter, the retrieved content can contain the message text as well as additional Javascript code that can interact with the primary web page to render and display the message.

On the Web server side, a Java servlet, JSP (Java server page), script or equivalent can respond to an incoming request. In this example, an implementation with a Java servlet is illustrated. Through the incoming request, the parameters can be passed in through the URL query string. This can be composed of:
1) the message key,
2) any replaceable parameters, and
3) a representation of the method to return the rendered message.
   The following is a sample URL of a request from client Javascript to the server:

http://server.ibm.com/myapp/rendermsg?key=filenotfound
&pl=myFile.txt&objname=errordiv

The servlet takes these parameters and looks up the corresponding message in a message catalog. It then inserts any specified parameters and passes the result into a rendering engine (i.e. JSP) that can format the output (i.e. HTML) for the requester.

There are several ways that this representation can be returned to the requester:
A) The passed in parameter 3 (here represented by the variable: objname) can be the ID of the recipient tag on the calling page:
   On the browser page rendered to the user, there is a placeholder for the rendered message (empty before the message request from the embedded IFRAME):

<div id=“errordiv”></div>

The completed pages from the URL called from the embedded IFRAME contain Javascript that modifies the tag shown above (in the primary window). The following is some sample servlet code that performs this operation:

```
PrintWriter p = resp.getWriter( );
p.println(“<HTML><BODY><script“ +
    ” type=\“text/javascript\”>”) ;
p.print(“parent.document.getElementById(‘“
    + objname + ”’).innerHTML=’”);
/* message rendering print statements */
p.println(“‘;</script></BODY></HTML>”);
p.flush( ); p.close( );
```

To notify the browser page that the message update is complete, a variable can be set on the primary window by the secondary window.
B) The passed in parameter 3 (here represented by the variable: objname) can be the ID given to the rendered message in the secondary window (IFRAME) in which the primary window will pull from:
   On the browser page, a call is made to the server using the IFRAME.
   The rendered message could be generated by this servlet code snippet:

PrintWriter p = resp.getWriter( );
p.println(“<HTML><BODY><DIV id=‘“
+ objname + ”’>”);
/* message rendering print statements */
p.println(“</DIV></BODY></HTML>”);
p.flush( ); p.close( );

When the message rendering is complete, i.e. by setting a flag notifying the primary window, the primary window can pull the rendered DIV from the secondary IFRAME. It can replace an element on the main page with this DIV, make the IFRAME visible to show the message, or use it any other way.
C) The passed in parameter 3 (here represented by the variable: objname) can be the Javascript variable name of the rendered message:
   On the browser page, a call is made using the IFRAME.
   The rendered message could be represented by this code snippet:

PrintWriter p = resp.getWriter( );
p.println(“<HTML><BODY><script“ +
” type=\“text/javascript\”>”);
p.println(“var “ + objname + ”=’”);
/*message rendering print statements */
p.println(“‘;</script></BODY></HTML>”);
p.flush( ); p.close( );

When the message rendering is complete, the primary window can use the resultant object from the secondary IFRAME after it is notified.

FIG. 4 is a block diagram that schematically illustrates a system for managing server-based rendering of messages in a data processing system according to an exemplary embodiment. The system is generally designated by reference number 400, and includes Web browser primary page 410 and server 420. Applet 412 or browser-side Javascript 414 updates the source object of hidden IFRAME 416 with the URL of a message rendering servlet as shown by arrows 430. The URL contains a message key, parameters for the message and an object ID for the target of the message. The browser detects that the IFRAME source object has changed and contacts server 420 using the URL as shown by arrow 432.

On server 420, servlet/JSP or script 422 looks up the appropriate message from message catalog 424 as shown by arrows 434, inserts parameters and renders HTML/Javascript code. The HTML/Javascript code containing the message rendering instructions is returned to the client browser's hidden IFRAME 416 as shown by arrow 436.

The browser then processes the returned HTML/Javascript to provided displayed message 418 as shown by arrow 438. Depending on what the HTML/Javascript contains, the browser can:
A) Use the object ID of the target element in Web browser primary page 410 to display the rendered message;
B) Use the object ID of the target element within hidden IFRAME 416 to render the message. Web browser primary page 410 is then notified and can then display the rendered message from hidden IFRAME 416; or
C) Store the rendered message in a Javascript variable in hidden IFRAME 416. Web browser primary page 410 is then notified and it can access the variable to display the rendered message.

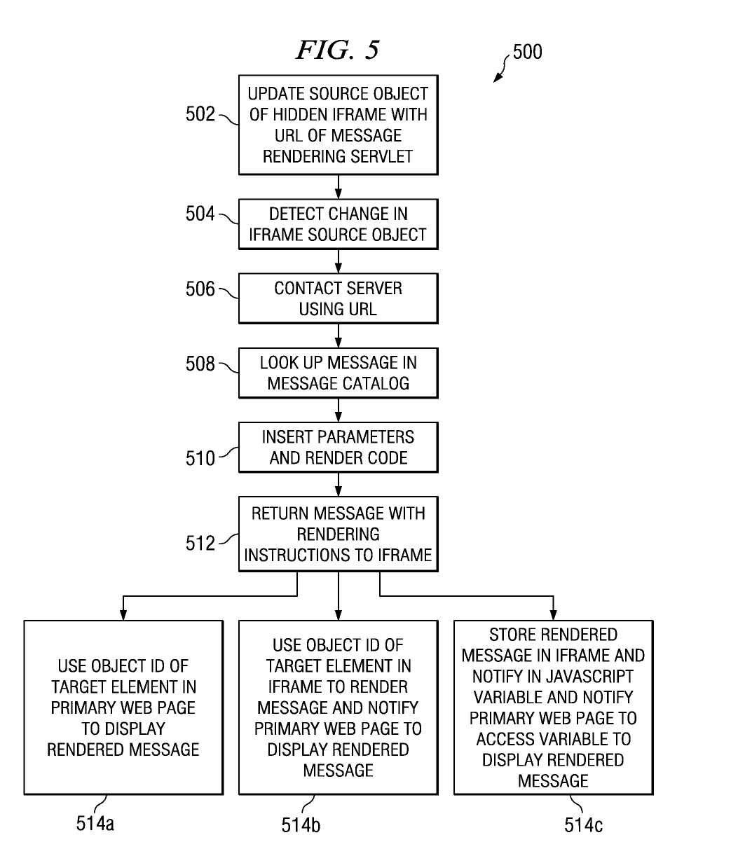

FIG. 5 is a flowchart that illustrates a computer implemented method for managing server-based rendering of messages in a data processing system according to an exemplary embodiment. The method is generally designated by reference number 500, and begins by updating the source object of a hidden IFRAME in a Web browser with the URL of a message rendering servlet (Step 502). The browser detects that the hidden IFRAME source object has changed (Step 504), and contacts the remotely located server using the URL (Step 506).

On the server, a servlet/JSP or script then looks up the appropriate message from a message catalog in the server (Step 508), inserts parameters and renders HTML/Javascript code (Step 510). The HTML/Javascript code containing the message rendering instructions is then returned to the hidden IFRAME in the browser (Step 512). The browser processes the returned HTML/Javascript depending on what the HTML/Javascript contains. As described previously, the processing can include one of using the object ID of the target element in the primary web page to display the rendered message (Step 514a); use the object ID of the target element within the hidden IFRAME (secondary web page) to render the message, and notify the primary web page to display the rendered message (Step 514b); or store the rendered message in a Javascript variable in the hidden IFRAME, and notify the primary web page so that it can access the variable to display the rendered message (Step 514c). After processing the HTML/Javascript in one of these manners, the method ends.

Exemplary embodiments thus provide a computer implemented method, system and computer usable program code for rendering messages in a data processing system. A computer implemented method for rendering a message in a data processing system includes updating a source object of a secondary web page associated with a primary web page with information regarding a message to be rendered. The information is transmitted to a remote location using the secondary web page. Message code is received from the remote location that includes the message to be rendered and message rendering instructions, and the received message code is processed to render the message for display on the primary web page.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for rendering a message in a data processing system, the computer implemented method comprising:
updating a source object of a secondary web page associated with a primary web page with information regarding a message to be rendered;
transmitting the information to a remote location using the secondary web page;
receiving message code from the remote location, the message code including the message to be rendered and message rendering instructions; and
processing the received message code to render the message for display on the primary web page.

2. The computer implemented method according to claim 1, wherein the secondary web page is a hidden web page embedded in the primary web page, and wherein transmitting the information to a remote location using the secondary web page comprises:
transmitting the information to a remote location using the secondary web page via a background connection to the remote location.

3. The computer implemented method according to claim 2, wherein the secondary web page comprises an IFRAME object.

4. The computer implemented method according to claim 1, wherein transmitting the information to a remote location using the secondary web page comprises:
transmitting the information to a remote location via a URL.

5. The computer implemented method according to claim 1, wherein the transmitted information includes a message key to enable access to a message catalog at the remote location, parameters for the message to be rendered for display, and a representation of a method for returning the message to be rendered for display.

6. The computer implemented method according to claim 5, and further comprising:
displaying the rendered message on the primary web page, wherein the representation of a method for returning the message to be rendered for display comprises one of:
using an object identification of a target element in the primary web page to display the rendered message;
using an object identification of a target element in the secondary web page and notify the primary web page to display the rendered message; and
storing the rendered message in a Javascript variable in the secondary web page and notify the primary web page to access the Javascript variable and display the rendered message.

7. The computer implemented method according to claim 1, and further comprising:
detecting that the source object has been updated prior to transmitting the information to the remote location.

8. The computer implemented method according to claim 1, wherein the remote location comprises a server having a message catalog, and wherein the server looks up the message in the message catalog using the transmitted information.

9. The computer implemented method according to claim 1, wherein the message to be rendered for display comprises a message in a selected language.

10. A computer program product, comprising:
a computer usable medium having computer usable program code configured for rendering a message in a data processing system, the computer program product comprising:
computer usable program code configured for updating a source object of a secondary web page associated with a primary web page with information regarding a message to be rendered;
computer usable program code configured for transmitting the information to a remote location using the secondary web page;
computer usable program code configured for receiving message code from the remote location, the message code including the message to be rendered and message rendering instructions; and
computer usable program code configured for processing the received message code to render the message for display on the primary web page.

11. The computer program product according to claim 10, wherein the secondary web page is a hidden Web page embedded in the primary web page, and wherein the computer usable program code configured for transmitting the information to a remote location using the secondary web page comprises:
computer usable program code configured for transmitting the information to a remote location using the secondary web page via a background connection to the remote location.

12. The computer program product according to claim 11, wherein the secondary web page comprises an IFRAME object.

13. The computer program product according to claim 10, wherein the computer usable program code configured for transmitting the information to a remote location using the secondary web page comprises:
computer usable program code configured for transmitting the information to a remote location via a URL.

14. The computer program product according to claim 10, wherein the transmitted information includes a message key to enable access to a message catalog at the remote location, parameters for the message to be rendered for display, and a representation of a method for returning the message to be rendered for display, and wherein the computer program product further comprises:
computer usable program code configured for displaying the rendered message on the primary web page, wherein the representation of a method for returning the message to be rendered for display comprises one of:
using an object identification of a target element in the primary web page to display the rendered message;
using an object identification of a target element in the secondary web page and notify the primary web page to display the rendered message; and
storing the rendered message in a Javascript variable in the secondary web page and notify the primary web page to access the Javascript variable and display the rendered message.

15. The computer program product according to claim 10, and further comprising:
computer usable program code configured for detecting that the source object has been updated prior to transmitting the information to the remote location.

16. The computer program product according to claim 10, wherein the message to be rendered for display comprises a message in a selected language.

17. A system for rendering a message in a data processing system, comprising:
a Web browser primary web page;
a secondary web page associated with the primary web page for containing information regarding a message to be rendered;
a transmitting mechanism for transmitting the information to a remote location using the secondary web page;
a receiving mechanism for receiving message code from the remote location, the message code including the message to be rendered and message rendering instructions; and
a processor for processing the received message code to render the message for display on the primary web page.

18. The system according to claim 17, wherein the secondary web page is a hidden web page embedded in the primary web page, and wherein the transmitting mechanism transmits the information to the remote location using the secondary web page via a background connection to the remote location.

19. The system according to claim 17, wherein the transmitted information includes a message key to enable access to a message catalog at the remote location, parameters for the message to be rendered for display, and a representation of a method for returning the message to be rendered for display.

20. The system according to claim 19, and further comprising:
a display mechanism for displaying the rendered message on the primary web page, wherein the representation of a method for returning the message to be rendered for display comprises one of:
using an object identification of a target element in the primary web page to display the rendered message;
using an object identification of a target element in the secondary web page and notify the primary web page to display the rendered message; and
storing the rendered message in a Javascript variable in the secondary web page and notify the primary web page to access the Javascript variable and display the rendered message.
